(19) United States
(12) Patent Application Publication
(10) Pub. No.: US 2022/0174147 A1
(43) Pub. Date: Jun. 2, 2022

(54) SYSTEM AND METHOD FOR INTELLIGENT VOICE SEGMENTATION

(71) Applicant: Avaya Management L.P., Durham, NC (US)

(72) Inventors: Shamik Shah, Pune (IN); Valentine C. Matula, Granville, OH (US)

(21) Appl. No.: 17/107,556

(22) Filed: Nov. 30, 2020

(51) Int. Cl. H04M 3/22; G10L 15/22; G10L 15/26; H04L 12/58

(52) U.S. Cl. CPC H04M 3/2218; H04M 3/2281; H04L 51/02; G10L 15/26; G10L 15/222

(57) ABSTRACT

Human agents may be repeatedly provide the same content to customers. Often the content may be the result of an event giving no notice (e.g., a network outage). Systems and methods are provided herein to automatically determine when agent(s) are providing the same content to customers. As a result, the system may capture the agent's speech and, when encountering a precursor speech in a subsequent communication, the system automatically inserts the recording or generated speech into the communication.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for machine-based communications and particularly to for machine-provided communication content.

### BACKGROUND

In any contact center, agent utilization is of prime importance and an agent's productivity directly affects the success rate of the calls as well as customer satisfaction. During a normal day agent may provide customers with specific content, such as data specific to a particular customer, and general content, such as content that is applicable to all or a plurality of customers. For example, a greeting or an announcement that the call will be recorded may be provided to each customer with whom an agent speaks. The customer may then provide more specific information, such as to provide or receive customer-specific information. General content may be provided elsewhere in the call, such as the end, such as a, “thank you for calling,” announcement.

### SUMMARY

Having agents repeat general content unnecessarily ties-up the agent. This can be exacerbated during “rainy day” scenarios when the contact center receives calls for services failures and the pre-programmed voice-response system is not configured to provide the necessary information. As a result, agents may see a marked increase in calls only to provide the same information, such as, “we are aware of a service outage that is affecting your service and we are working to resolve the issue as soon as possible. We do not have a current estimate as to when service will be restored.” As a result of providing this generic information to all customers, or an identified subset of customers, calls to address other issues experience longer hold times and decreased customer satisfaction.

Systems and methods provided herein automatically detect when general content is being provided then make the general content available as the agent's speech to subsequent calls. As a result, the agent may be able to attend to other tasks, or drop the call completely, while the automated systems provide content to the customer.

These and other needs are addressed by the various embodiments and configurations of the present invention. The present invention can provide a number of advantages depending on the particular configuration. These and other advantages will be apparent from the disclosure of the invention(s) contained herein.

As a general introduction, and in one embodiment, prompts and recording are automatically created from live conversations when such prompts and recordings are recognized as common to a number of calls. As used herein, “provided content” refers to content provided by at least one microprocessor (or “processor”) as generated and/or recorded content that is played back as a portion of the communication presented to the customer's communication device and optionally to other components, such as the agent's communication device, monitoring components, live-recording components, etc. Provided content is variously embodied and embodiments include the provided content comprising one or more of audio, video, audio-video, and/or text.

While embodiments herein are primarily directed towards audio calls, in other embodiments, content may be provided in audio-video and/or text-based communications. The detection and creation of prompts and recordings may be specific to a single agent or common to a number of agents.

In another embodiment, portions of the recorded may be altered, such as to provide all or a portion of the provided content specific to a particular customer, client (e.g., operator or contractor of the contact center for which the agent is providing services), or other variable. For example, provided content may be modified such as to include, “I'm sorry, Mr. Smith. Your service, and all of Elm Street is currently out and repairs are underway,” as a customer-specific modification, “Company X values your business and apologizes for the service outage,” as a client specific modification, and, “Ms. Jones, as you are a new customer of Company Y, we want you to know that the current outage is unusual and that you chose one of the most reliable providers,” as both a client-specific and customer-specific modification, “Good morning, the current outage,” to include a time-variable portion.

As agents tend to repeat the same information to many customers over the day or over a period of time. The current solutions of pre-recorded welcome or in-conversation messages help agents to initiate the conversation, or to play an agent-conceived in-conversation message. These messages may sound ‘odd’, due to out-of-context recording, and may not contain the actual information used during live calls with the customer. In another embodiment, the wording, tone, pace, inflection, emotion, etc., may be altered to correspond to the wording, tone, pace, inflection, emotion, etc., of the content provided by the agent and thereby avoid unnatural wording or otherwise present the recording having tonal, pacing, and/or other attributes similar to that of the prior live content. In another embodiment, a processor may determine the provided content and generate speech and/or generate text which may further be converted to speech. Such a text-to-speech generation may be trained specifically for the agent and/or modified to comport with the prior agent-provided content. Additionally or alternatively, automatic monitoring may be provided to determine when a prompt or recording is in need for updating, such as due to lack of use or when an agent or customer provides negative feedback, (e.g., “Why did you tell me that?” “That isn't why I called.” etc.).

In one embodiment, content provided by an agent or agents is provided to an artificial intelligent (AI) system, such as machine-learning, neural network, etc., which may require speech-to-text conversion first. As speech, even speech providing the same substantive message, will likely have variations to wording, non-identical speech may be identified as having the same substantive content. The AI system may determine that a common speech is detected and isolated for presentation as a segment of speech, comprising the common speech, from a prior usage to be utilized in future conversations. Additionally or alternatively, the result from the AI system may automatically be added to a soft-button selection or automatically included in future conversations, which may be labeled with an indicia of the common speech to be utilized as the provided content. In a further embodiment, a current conversation may be monitored to determine that a particular provided content is likely to be needed and, if so, a soft-button can be programmed with the particular provided content, an existing option to select the provided content may be highlighted or otherwise emphasized, or automatically provided by the system. Agents may have the option to approve, remove, re-record, edit, or otherwise modify the speech utilized for the provided content.

In yet another embodiment, periodically or randomly, agents may be prompted to provide speech of the provided content themselves and not by the automated system. The results of the agent provided content versus system provided content may be utilized to ensure the provided content remains relevant and useful or, in contrast, indicates a need for updating or discarding.

In one embodiment, a system is disclosed, comprising: a network interface to a network; a storage device; a processor comprising a non-transitory memory having machine-readable instructions that cause the processor to: analyze a communication between a customer, utilizing a customer communication device, and an agent utilizing an agent communication device to communicate via the network; determine a live content of the communication; determine a match of the live content to a record of a number of records maintained in the data storage, wherein the record comprises provided content that has not yet been provided in the communication; and insert the provided content to communication for presentation by the customer communication device.

In another embodiment, a method is disclosed comprising: analyzing a communication between a customer, utilizing a customer communication device, and an agent utilizing an agent communication device to communicate via a network; determining a live content of the communication; and determining a match of the live content to a record of a number of records maintained in a data storage, wherein the record comprises provided content that has not yet been provided in the communication; and inserting the provided content to communication for presentation by the customer communication device.

In another embodiment, an agent communication device is disclosed, comprising: a network interface to a network; a storage device; a processor comprising a non-transitory memory having machine-readable instructions that cause the processor to: access a plurality of prior communications between the agent and a plurality of prior customers; analyze the plurality of prior communications for frequency of use of multi-word phrases within each of the plurality of prior communications, and upon determining an outlier of the multi-word phrases having at least one of a statistically significant usage or a statistically significant increase in usage, populating one of the number of records with the outlier as provided content for the one of the number of records comprising a recording of speech provided by the agent in response to a prompt to provide the provided content; analyze a communication between a customer, utilizing a customer communication device, and an agent utilizing the agent communication device to communicate via the network; determine a live content of the communication; determine a match of the live content to a record of a number of records maintained in the data storage, wherein the record comprises provided content that has not yet been provided in the communication; present indicia of the provided content to receive an approval; upon receiving the approval further comprising an edit, modifying the provided content in accordance with the edit and inserting the provided content to communication for presentation by the customer communication device; and upon not receiving the approval within a previously determined period of time, inserting the provided content to communication for presentation by the customer communication device.

A system on a chip (SoC) including any one or more of the above aspects.

One or more means for performing any one or more of the above aspects.

Any one or more of the aspects as substantially described herein.

Any of the above aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a data structure in accordance with embodiments of the present disclosure;

FIG. 4 depicts a first distribution of phrases in accordance with embodiments of the present disclosure;

FIG. 5 depicts a second distribution of phrases in accordance with embodiments of the present disclosure;

FIG. 6 depicts content presented on a display of an agent communication device in accordance with embodiments of the present disclosure;

FIG. 7 depicts a first process in accordance with embodiments of the present disclosure;

FIG. 8 depicts a second process in accordance with embodiments of the present disclosure; and

FIG. 9 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

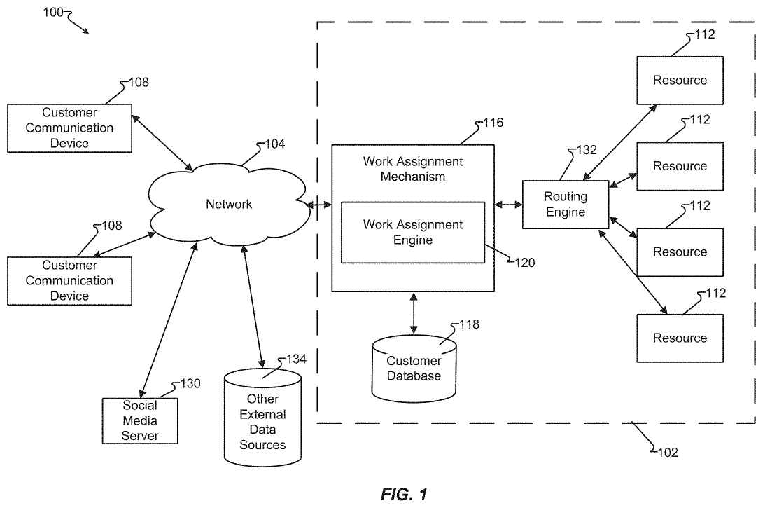

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to customer communication devices. In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the customer communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

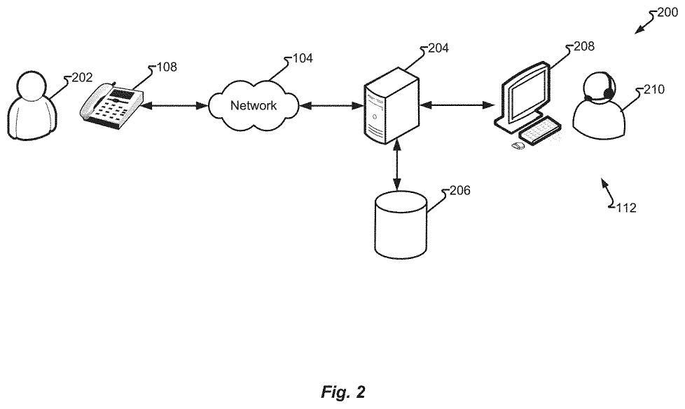

FIG. 2 depicts system 200 in accordance with embodiments of the present disclosure. In one embodiment, system 200 illustrates a portion of communication system 100, wherein portions are omitted to avoid unnecessarily complicating the figure and associated description. In one embodiment, customer 202 is engaged in a communication with resource 112, such as agent 210 utilizing agent communication device 208. In one embodiment, the communication may be voice communication. Additionally or alternatively, the communication may comprise text and/or video.

The reason (i.e., subject, domain, etc.) for the communication may be relatively uncommon, compared to all the calls received by agent 210 and/or a pool of agents (e.g., plurality of resources 112 embodied as live agents utilizing an agent communication device) of contact center 102 which may or may not comprise agent 210. If the reason is sufficiently uncommon, agent 210 proceeds to gather and/or provide information to resolve the reason for the communication. For example, a specific billing issues encountered by customer 202 may have details that are a single occurrence, and therefore uncommon, within the realm of all communications or even all billing issues. Accordingly, agent 210 may be utilized to assist customer 202 in resolving the issue.

In other instances, the reason of the communication or a portion of the communication may be relatively common where customers are provided with the same information repeatedly. For example, agent 210 may have already provided the content, such as information regarding a service outage, to a number of prior customers during prior communications. Now, customer 202 is asking about service issues and, explicitly or implicitly, asking for the same information agent 210 and/or other agents, have previously provided to other customers. Therefore, to avoid unnecessarily keeping agent 210 on the communication in order to provide common information, server 204 may detect the content of the communication will require previously provided content, such as may be maintained in data storage 206, and inserts the provided content into the communication to customer communication device 108 which may then decode the communication, now comprising the provided content, for presentation to customer 202. While the provided content is being presented by server 204, agent 210 may be idle, such as to resume the communication after the provided content has been delivered, or performing other tasks. Accordingly, agent communication device 208 may also present the provided content to agent 210, via agent communication device 208, or mute or otherwise omit the provided content from agent communication device 208. Server 204, such as at the conclusion of the presentation of the provided content, may signal agent communication device 208 to alert agent 210 to resume the communication or, if successfully completed, terminate the communication automatically.

As will be discussed more completely with respect to certain embodiments that follow, the provided content may be processor-generated speech, such as by a processor of server 204 accessing settings from data storage 206 or other non-transitory data storage to generate, such as from text utilizing a text-to-speech process or application for insertion of machine generated speech into the communication. In anther embodiment, the provided content may be a recording of agent 210, such as may be recorded during a previous communication with a prior customer. The recording is then captured as the provided content and played back and inserted into the communication. The recording may be a purposefully designated recording (e.g., a recording outside of any communication with any customer). For example, server 204 may prompt agent 210 to create a recording of a determined common phrase to use as provided content. Agent 210 may then utilize agent communication device 208 and speak the provided content which is then captured by a microphone (not shown) of agent communication device 208 and the recording maintained, such as in data storage 206 and/or other non-transitory data storage.

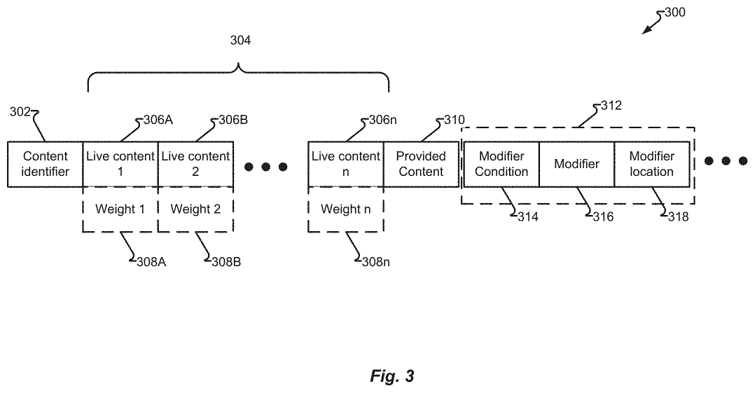

FIG. 3 depicts data structure 300 in accordance with embodiments of the present disclosure. In one embodiment, data structure 300 describes a number of records, such as may be maintained in a database and stored in data storage 206 and/or other data storage for access by a processor of server 204 and/or other computing device. Data structure 300 comprises a number of fields to describe provided content and related attributes of the provided content.

In one embodiment, content identifier 302 maintains an index, address, name, and/or other identifier of data structure 300. For example, content identifier 302 may describe a situation in human-readable form, such as, “service outage in locations X and Y.” In other embodiments, machine-readable descriptors and/or other identifiers may be utilized as content identifier 302. In another embodiment, live content block 304 describes one or more live occurrences of live content 306A-n that, during prior communications, was determined to be a precursor to agent 210 and/or other agents, speaking the provided content. For example, during prior communications, customers may have said phrases such as, “over the last hour, I haven't been able to connect,” “my service has been unavailable,” “I'm having problems connecting,” and/or similar phrases. Accordingly, a processor, such as a processor of server 204, upon encountering a subsequent utterance of live content 306, may be utilize as a trigger to initiate insertion of provided content 310.

There are almost limitless ways that the same spoken content may be phrased and mean the same thing. It is unlikely that customers will speak identical phrases, therefore, in another embodiment, systems and methods may be utilized to determine if what is spoken by a particular customer is, or is not, a trigger to insert provided content 310. It should be appreciated that other attributes of a customer, the call, the time/date of the call, etc., may be utilized in whole or in part as a trigger to insert provided content 310. For example, a customer calling from an address that is known to be experiencing internet outages, may have that location partially or entirely determine that provided content 310, related to an announcement regarding internet outages in that neighborhood, should be inserted. In yet another embodiment, the precursor content may be provided, entirely or in part, by agent 210. For example, “I see you're calling from 123 Main Street. I'm guessing your calling about internet connection issues.” To which customer 202 may only reply with, “that's correct.” As a result, provided content 310 may be inserted to provide customer 202 with information related to the internet outage.

In order to accommodate variations in human speech, an artificial intelligent (AI) may be utilized to determine if the words spoken by customer 202, and optionally agent 210, have a precursor meaning that should or should not trigger insertion of provided content 310. The AI, such as a neural network is provided, such as one or more processes embodied as machine-readable instructions maintained in a non-transitory memory and executed by a processor(s) of server 204, agent communication device 208 and/or other processing device(s) in communication with agent communication device 208. The neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

By way of example, a first layer of nodes may evaluate speech for nouns and verbs associated with a particular topic (e.g., connection, unable, internet, problem, etc.), where an such words are detected, the nodes provide an input to a next layer of nodes. The next layer of nodes may look for combination of words (e.g., internet unavailable, cannot connect, etc.) to delineate phrases associated with other topics (e.g., internet cost, payment failure, etc.). Such topics being outside of the current data structure 300, but for which may match an alternative data structure. Again, the nodes that find a target phase are active and provide an input to a next layer of nodes which may then look for particular series of words or phrases or other features. The process continues until a conclusion is reached that a particular issue is being raised by customer 202. Accordingly, one or more instances of live content 306 may have an associated weight 308A-n, respectively. As a result a weighting of a communication may be accumulative and, if over a threshold, determined to be a trigger and cause provided content 310 to be presented into the communication.

Provided content 310 may comprise a recording and/or settings that allow a processor to generate the speech to present provided content 310 to customer communication device 108 and customer 202. Settings may include text-to-speech content and settings (e.g., tone, pace, inflection, etc.) to be utilized when generating provided content. In another embodiment, provided content may comprise video, video portions, or settings such as to cause a video image of agent 210 to have the facial movement consistent with the speech provided by provided content 310.

In another embodiment, modifier block 312 may comprise fields to modify a particular provided content 310. For example, modifier condition 314 may provide condition-determined variations of provided content 310 or portions thereof, such as a name(s), “<Good morning> we apologize for the outage affecting all service <on Elm Street> and <Company X> values your business,” provided with modifier(s) 316 and placed within a portion of provided content 310 determined by modifier location 318. Therefore, as an alternative to providing stock phrasing of provided content 310, modifications may be provided, such as to reflect known but variable content (e.g., day, time, etc.), when the customer specific information (e.g., name, address, service level, etc.), name of the client of contact center 102, and/or other variations and where to place those portions (e.g., start-stop time, whether it is a true insert or what portion of provided content 310 will be overwritten, etc.).

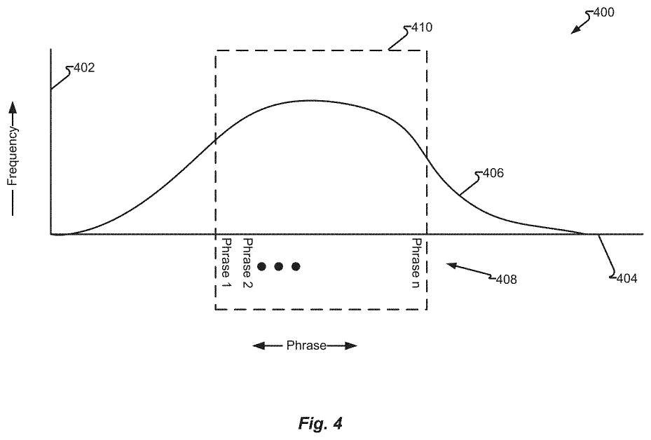

FIG. 4 depicts distribution of phrases 400 in accordance with embodiments of the present disclosure. In one embodiment, the determination of which phrases to include as provided content 310 may be determined based on their frequency of occurrence of phrases spoken by agent 210 and/or other agents. Once a phrase is determined, a processor may capture the speech or automatically, and without human intervention, capture the speech for use as provided content. Optionally, agent 210 may be presented with the captured content for approval and, as further option, reselection or re-recording if not acceptable.

Accordingly, distribution of phrases 400 may plot phrases along horizontal axis 404 and their frequency along vertical axis 402 with plot 406. It should be appreciated that machine-readable representations may be utilized in addition or alternative to human-readable graphical representations. Phrase subset 410 may comprise the most popular phrases 408. This may include generic or specific greetings (e.g., “Hello, I'm Agent Green. How can I help you?” “Hello, Mr. Jones, how can I help you this evening?”), conclusions (e.g., “Thanks for calling. Again my name is Agent Green, please stay on the line for a brief survey.”), mid-call insertions (e.g., “Before we can review the charges, it will take a moment to retrieve your account records.”) and/or other common occurrence of a phrase. In one embodiment, a phrase utilized as provided content herein comprises a plurality of words comprising a subject and predicate. In another embodiment, a phrase is a unitary piece of information, such as an address, account number, etc. In another embodiment, a phrase may be a combination of information, such as detailed instructions to perform an operation, present content such as a standardized legal disclaimer, etc. Phrase subset 410 may be identified as the most common phrases (e.g., phrases within one, two, or three standard deviations) spoken by agent 210 and/or other agents overall or specific to a particular topic or issue. Phrases outside of phrase subset 410 may be sufficiently uncommon or specific to warrant presentation by agent 210.

Therefore, a processor may determine that a phrase is within phrase subset 410 but is absent an associated record, such as a record having data structure 300 and maintained in data storage 206. Accordingly, phrases that are, or become, more popular may be added automatically as provided content 310.

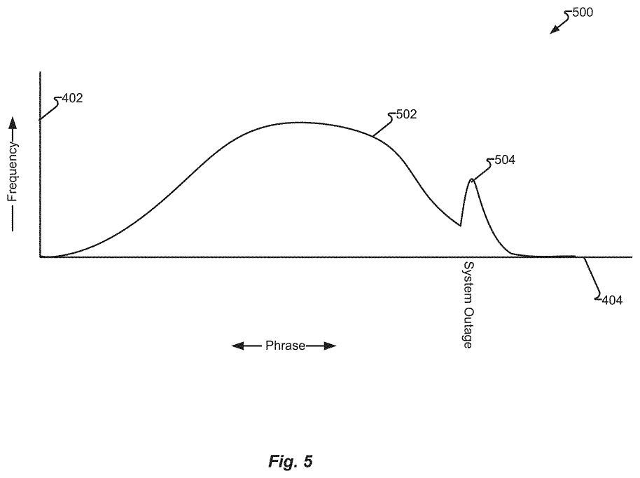

FIG. 5 depicts distribution of phrases 500 in accordance with embodiments of the present disclosure. In one embodiment, distribution of phrases 500 illustrates a statistical outlier or change in frequency for phrase 504 as plotted on plot 502. For example, phrase 504 may address a system outage that recently occurred. The frequency and/or the change in frequency may indicate that agent 210 and/or other agents may expect to encounter the need for provided content addressing the outage. Accordingly, a processor may initiate recording or capture a prior recording, as described herein, so that a response to the system outage may be provided as provided content for automatic insertion into the communication with a subsequent customer, such as customer 202.

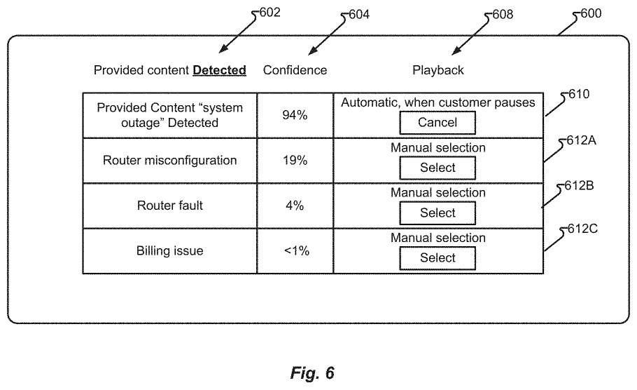

FIG. 6 depicts content presented on display 600 of an agent communication device in accordance with embodiments of the present disclosure. In order to avoid introducing confusion into the communication, display 600 may be presented on agent communication device 208 for viewing by agent 210. For example, announcement 602 may alert agent 210 that the need for provided content has been determined and, unless action is taken to prevent or alter the presentation of the provided content, the provided content will automatically be inserted into the communication. Optionally, announcement 602 may identify what has been detected, optionally with confidence score 604 and options 608 for a number of detected precursor events 610 and 612A-612C.

In one embodiment, precursor event 610 may have detected that customer 202 is asking about system outages with confidence score 604 and, absent an affirmative action by agent 210 upon content presented on display 600, the associated provided content will automatically be inserted into the communication. However, agent 210 may have determined that this is an error and customer 202 discussing something else. Agent 210 may elect to omit the automatic insertion (e.g., press a ‘cancel’ button) or to select a different option, such as those presented by precursor events 612A-612C.

As a further option, the use or non-use of a particular provided content may be provided back into the AI system, such as to down-weight options that are incorrect and/or up-weight options that are determined to be correct. Additionally or alternatively, provided content utilized by agent 210 may reach a predetermined threshold to cause the provided content to be utilized by other agents. If a particular provided content is being repeatedly selected but manually excluded, a processor of server 204 may down-weight the provided content, exclude the provided content, down-weight a particular precursor event (e.g., see live content 306A-n and associated weight 308A-n), so has to stop or decrease the provided content from being selected under similar precursor content (e.g., one of live content 306A-n) in the future.

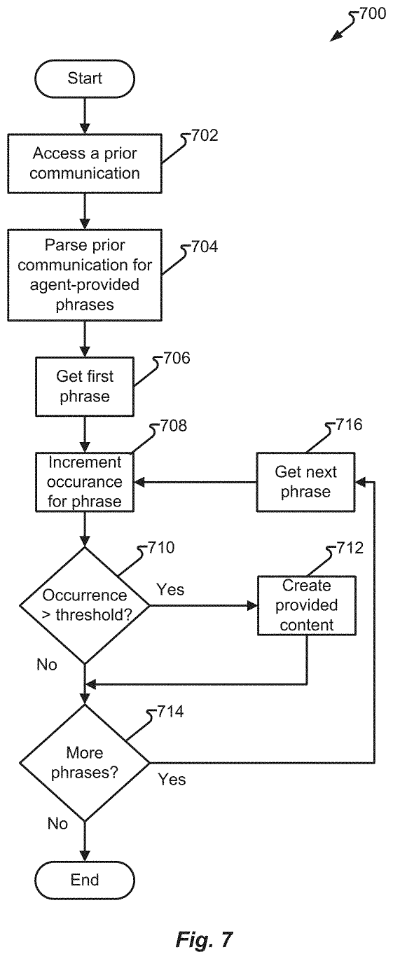

FIG. 7 depicts process 700 in accordance with embodiments of the present disclosure. In one embodiment, process 700 may be embodied as machine-readable instructions maintained in a non-transitory data storage, such as a processor of server 204 accessing the instructions from a memory in, or accessible to, server 204 and/or data storage 206, that when accessed cause the processor to execute the steps of process 700. Process 700 is generally directed to the machine-based determination of phrases provided in past communications to be included as provided content and made available for insertion into future communications with customers.

Process 700 begins, with step 702 accessing a communication. The communication may be a recorded communication or a currently ongoing communication (e.g., steps 702 and 704 may be executed intermittently or continually). Step 704 parses the communication for agent-provided phrases. Step 704 may be content provided by an agent in one continuous event, without the associated customer providing any of the communication content, or a portion thereof. Such as determined words forming a subject and predicate. Step 706 accesses a first phrase and step 708 increments the number of occurrences for the first phrase.

Next, test 710 determines if the number of occurrences is greater than a threshold value. The threshold value may be an absolute number, number over a given period of time, or an increase within a period of time. If test 710 is determined in the affirmative, step 712 creates the phrase as the provided content, such as by capturing a portion of the provided speech from the agent speaking the phrase (e.g., speaking first phrase accessed in step 706 and/or a subsequent phrase accessed in step 716). After step 712, or if test 710 is determined in the negative, processing continues to test 714 which determines if there are more phrases and, if so step 716 accesses the next phrase and processing loops back to step 708 utilizing the next phrase. If test 714 is determined in the negative process 700 may end or be re-initiated, such as with a different communications. The occurrence frequency for phrases encountered in different communications may be reset or maintained to determine a frequency for phrases provided by multiple agents.

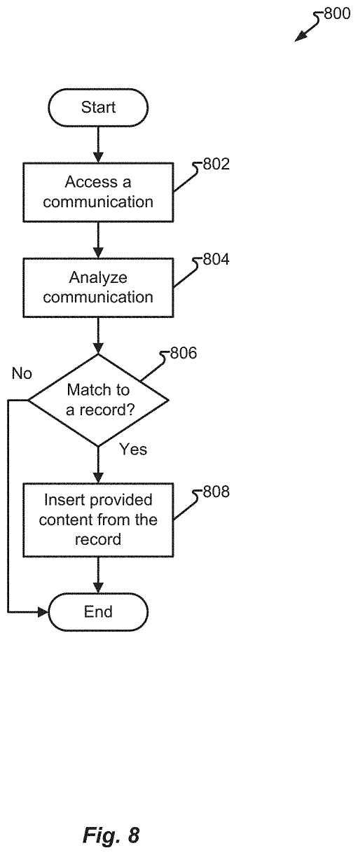

FIG. 8 depicts process 800 in accordance with embodiments of the present disclosure. In one embodiment, process 800 may be embodied as machine-readable instructions maintained in a non-transitory data storage, such as a processor of server 204 accessing the instructions from a memory in, or accessible to, server 204 and/or data storage 206, that when accessed cause the processor to execute the steps of process 800. Process 800 is generally directed to determining that provided content is to be inserted into a communication with customer 202.

Process 800 begins, and a current communication is accessed in step 802, such as between customer 202 and agent 210. Step 804 analyzes the communication, such as to determine whether customer 202 (and/or agent 210) is providing content into the communication that may be a precursor to provided content. For example, customer 202 may speak content identified as live content (see, live content 306) directly or an equivalent determined by the AI. Accordingly, step 706 determines if the communication matches a record, such as a record within data storage 206 having data structure 300 and at least one live content 306 (alone or with sufficient associated weight 308). If test 806 is determined in the negative, agent 210 continues to provide the content of the communication. If test 806 is determined in the affirmative, step 808 inserts the provided content (see provided content 310) into the communication. Optionally, the processor may modify the speech (e.g., one or more of tone, pace, emotion, inflection) to match the speech provided by agent 210. As a further option, modifications, such as maintained in modifier block 312 may be applied and inserted in step 808.

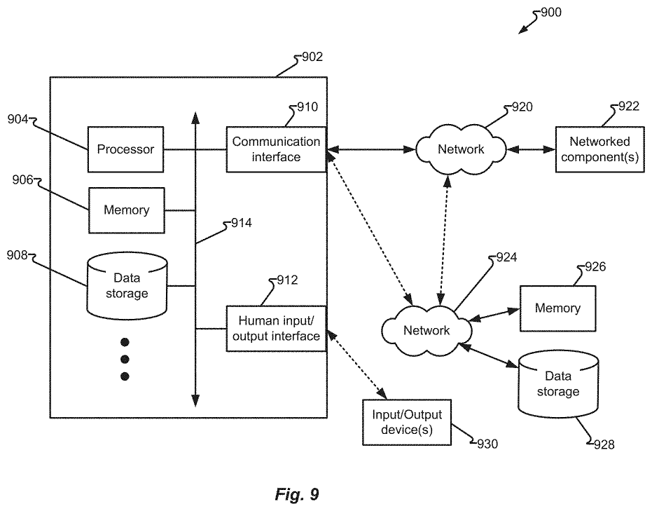

FIG. 9 depicts device 902 in system 900 in accordance with embodiments of the present disclosure. In one embodiment, server 204 and/or agent communication device 208 may be embodied, in whole or in part, as device 902 comprising various components and connections to other components and/or systems. The components are variously embodied and may comprise processor 904. The term “processor,” as used herein, refers exclusively to electronic hardware components comprising electrical circuitry with connections (e.g., pin-outs) to convey encoded electrical signals to and from the electrical circuitry. Processor 904 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 914, executes instructions, and outputs data, again such as via bus 914. In other embodiments, processor 904 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 904 is a non-transitory computing device (e.g., electronic machine comprising circuitry and connections to communicate with other components and devices). Processor 904 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 904). Processor 904 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 904, device 902 may utilize memory 906 and/or data storage 908 for the storage of accessible data, such as instructions, values, etc. Communication interface 910 facilitates communication with components, such as processor 904 via bus 914 with components not accessible via bus 914. Communication interface 910 may be embodied as a network port, card, cable, or other configured hardware device. Additionally or alternatively, human input/output interface 912 connects to one or more interface components to receive and/or present information (e.g., instructions, data, values, etc.) to and/or from a human and/or electronic device. Examples of input/output devices 930 that may be connected to input/output interface include, but are not limited to, keyboard, mouse, trackball, printers, displays, sensor, switch, relay, speaker, microphone, still and/or video camera, etc. In another embodiment, communication interface 910 may comprise, or be comprised by, human input/output interface 912. Communication interface 910 may be configured to communicate directly with a networked component or utilize one or more networks, such as network 920 and/or network 924.

Network 104 may be embodied, in whole or in part, as network 920. Network 920 may be a wired network (e.g., Ethernet), wireless (e.g., WiFi, Bluetooth, cellular, etc.) network, or combination thereof and enable device 902 to communicate with network component(s) 922. In other embodiments, network 920 may be embodied, in whole or in part, as a telephony network (e.g., public switched telephone network (PSTN), private branch exchange (PBX), cellular telephony network, etc.)

Additionally or alternatively, one or more other networks may be utilized. For example, network 924 may represent a second network, which may facilitate communication with components utilized by device 902. For example, network 924 may be an internal network to a business entity or other organization, such as contact center 102, whereby components are trusted (or at least more so) that networked components 922, which may be connected to network 920 comprising a public network (e.g., Internet) that may not be as trusted.

Components attached to network 924 may include memory 926, data storage 928, input/output device(s) 930, and/or other components that may be accessible to processor 904. For example, memory 926 and/or data storage 928 may supplement or supplant memory 906 and/or data storage 908 entirely or for a particular task or purpose. For example, memory 926 and/or data storage 928 may be an external data repository (e.g., server farm, array, “cloud,” etc.) and allow device 902, and/or other devices, to access data thereon. Similarly, input/output device(s) 930 may be accessed by processor 904 via human input/output interface 912 and/or via communication interface 910 either directly, via network 924, via network 920 alone (not shown), or via networks 924 and 920. Each of memory 906, data storage 908, memory 926, data storage 928 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 930 may be a router, switch, port, or other communication component such that a particular output of processor 904 enables (or disables) input/output device 930, which may be associated with network 920 and/or network 924, to allow (or disallow) communications between two or more nodes on network 920 and/or network 924. For example, a connection between one particular customer, using a particular customer communication device 108, may be enabled (or disabled) with a particular networked component 922 and/or particular resource 112. Similarly, one particular networked component 922 and/or resource 112 may be enabled (or disabled) from communicating with a particular other networked component 922 and/or resource 112, including, in certain embodiments, device 902 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network;
a storage device; and
a processor comprising a non-transitory memory having machine-readable instructions that cause the processor to:
analyze a communication between a customer, utilizing a customer communication device, and an agent utilizing an agent communication device to communicate via the network;
determine a live content of the communication;
determine a match of the live content to a record of a number of records maintained in the data storage, wherein the record comprises provided content that has not yet been provided in the communication; and
insert the provided content to communication for presentation by the customer communication device.

2. The system of claim 1, wherein the record comprises the provided content further comprising at least one of: an audio recording wherein inserting the provided content further comprises playback of the audio recording or speech generation settings wherein inserting the provided content further comprises the processor executing the machine-readable instructions to generate speech of the provided content.

3. The system of claim 1, wherein the machine-readable instructions further cause the processor to, prior to the communication between the customer and the agent:
access a plurality of prior communications between the agents and an associated plurality of prior customers; and
analyze the plurality of prior communications for frequency of use of multi-word phrases within each of the plurality of prior communications, and upon determining an outlier of the multi-word phrases having at least one of a statistically significant usage or a statistically significant increase in usage, populating one of the number of records with the outlier as provided content for the one of the number of records.

4. The system of claim 3, wherein the processor accesses the plurality of prior communications comprising a plurality of prior communications between a pool of agents and an associated pool of prior customers.

5. The system of claim 1, wherein insertion of the provided content comprises the processor executing the machine-readable instructions to modify the provided content to resemble speech provided by the agent.

6. The system of claim 5, wherein the instructions to modify the provided content comprise instructions to alter at least one of tone, pace, emotion, or inflection of the provided content to match an associated at least one of the tone, pace, emotion, or inflection of the speech provided by the agent.

7. The system of claim 1, wherein the provided content inserted into the communication comprises at least one of voice, text, or video overlay of at least the mouth of the agent to present a video image of the agent, as presented to the customer communication device, as appearing to speak the provided content.

8. The system of claim 1, wherein:
the data storage comprises a configuration record having a configured content portion; and
the machine-readable instructions further cause the processor to customize the provided content with at least one of the addition of the configured content portion prior for insertion into the communication.

9. The system of claim 1, wherein the machine-readable instructions further cause the processor to:
determine the match, with varying degrees of certainty, between the live content and each of a plurality of records of the number of records; and
insert the provided content associated with one of the plurality of records of the number of records having the highest degree of certainty.

10. The system of claim 1, wherein the machine-readable instructions further cause the processor to:
determine the match, with varying degrees of certainty, between the live content and each of a plurality of records of the number of records;
present an ordered list of indicia of the records having list elements associated with the plurality of records to the agent communication device; and
upon receiving an input on the agent communication device selecting one of the ordered list, insert the provided content associated selected one of the ordered list.

11. The system of claim 9, wherein the machine-readable instructions further cause the processor to:
determine the match, with a degree of certainty, between the live content and each of a plurality of records of the number of records;
insert the provided content of one of the plurality of records associated with the highest degree of certainty; and
after inserting the provided content to communication for presentation by the customer communication device, receive from the customer communication device, a success indicator indicating one of success, adjust the degree of certainty of the record associated with the highest degree of certainty in accordance with the success indicator.

12. A method, comprising:
analyzing a communication between a customer, utilizing a customer communication device, and an agent utilizing an agent communication device to communicate via a network;
determining a live content of the communication;
determining a match of the live content to a record of a number of records maintained in a data storage, wherein the record comprises provided content that has not yet been provided in the communication; and
inserting the provided content to communication for presentation by the customer communication device.

13. The method of claim 12, wherein the record comprises the provided content further comprising at least one of: an audio recording wherein inserting the provided content further comprises playback of the audio recording or speech generation settings wherein inserting the provided content further comprises the processor executing the machine-readable instructions to generate speech of the provided content.

14. The method of claim 12, further comprising:
accessing a plurality of prior communications between the agents and an associated plurality of prior customers; and
analyzing the plurality of prior communications for frequency of use of multi-word phrases within each of the plurality of prior communications, and upon determining an outlier of the multi-word phrases having at least one of a statistically significant usage or a statistically significant increase in usage, populating one of the number of records with the outlier as provided content for the one of the number of records.

15. The method of claim 14, wherein accessing the plurality of prior communications further comprising accessing a plurality of prior communications between a pool of agents and an associated pool of prior customers.

16. The method of claim 12, wherein insertion of the provided content comprises, prior to the inserting, modifying the provided content to resemble speech provided by the agent in the communication.

17. The method of claim 16, wherein modifying the provided content comprises altering at least one of tone, pace, emotion, or inflection of the provided content to match an associated at least one of the tone, pace, emotion, or inflection of the speech provided by the agent.

18. The method of claim 12, wherein the provided content inserted into the communication comprises at least one of voice, text, or video overlay of at least the mouth of the agent to present a video image of the agent, as presented to the customer communication device, as appearing to speak the provided content.

19. The method of claim 12, wherein:
accessing a data storage comprising a configuration record having a configured content portion; and
customizing the provided content with at least one of the addition of the configured content portion prior for insertion into the communication.

20. An agent communication device, comprising:
a network interface to a network;
a storage device; and
a processor comprising a non-transitory memory having machine-readable instructions that cause the processor to:
access a plurality of prior communications between the agent and a plurality of prior customers;
analyze the plurality of prior communications for frequency of use of multi-word phrases within each of the plurality of prior communications, and upon determining an outlier of the multi-word phrases having at least one of a statistically significant usage or a statistically significant increase in usage, populating one of the number of records with the outlier as provided content for the one of the number of records comprising a recording of speech provided by the agent in response to a prompt to provide the provided content;
analyze a communication between a customer, utilizing a customer communication device, and an agent utilizing the agent communication device to communicate via the network;
determine a live content of the communication;
determine a match of the live content to a record of a number of records maintained in the data storage, wherein the record comprises provided content that has not yet been provided in the communication;
present indicia of the provided content to receive an approval;
upon receiving the approval further comprising an edit, modifying the provided content in accordance with the edit and inserting the provided content to communication for presentation by the customer communication device; and
upon not receiving the approval within a previously determined period of time, inserting the provided content to communication for presentation by the customer communication device.
